(19) United States
(12) Patent Application Publication
(10) Pub. No.: US 2013/0058598 A1
(43) Pub. Date: Mar. 7, 2013

(54) INNER RAIL RELEASE AND POSITIONING STRUCTURE

(71) Applicants: Te-Jeng CHANG, New Taipei City (TW); Sung-Mu Chiang, New Taipei City (TW)

(72) Inventors: Te-Jeng CHANG, New Taipei City (TW); Sung-Mu Chiang, New Taipei City (TW)

(21) Appl. No.: 13/226,598

(22) Filed: Sep. 7, 2011

(51) Int. Cl. F16C 29/02

(52) U.S. Cl. 384/41

(57) ABSTRACT

An inner rail release and positioning structure includes a release spring plate and having an extension arm defining a first inclined portion, a relatively shorter second inclined portion obliquely extended from the first inclined portion and a relatively longer third inclined portion obliquely extended from the second inclined portion remote from the first inclined portion at a relatively smaller inclined angle than the inclined angle of the second inclined portion, a stop member engageable with the release spring plate, a damping spring plate for stopping against the stop member to prohibited the extended inner rail from backward displacement and defining a front damping portion obliquely outwardly extended from the mounting base thereof, a connection portion, a rear damping portion and a rear support portion for allowing quick dismounting of the inner rail.

### BACKGROUND OF THE INVENTION

1. Field of the Invention

The present invention relates to sliding rail technology and more particularly, to an inner rail release and positioning structure used in a sliding rail assembly, which holds the inner rail positively in position when the inner rail is extended out, allows the inner rail to be directly moved from the extended position to the received position or without operating any locking mechanism or directly detached from the outer rail (or intermediate rail) simply by means of pressing a release spring plate that does not cause much friction during sliding movement of the inner rail.

2. Description of the Related Art

In a two-step sliding rail assembly 6 consisting of an inner rail 61 and an outer rail 62 (see FIG. 2) or a three-step sliding rail assembly 7 consisting of an inner rail 71, an intermediate rail 72 and an outer rail 73 (see FIG. 1), a release member 64 or 74 may be provided at the inner rail 61 or 71, and a stop member 65 or 75 may be provided at the outer rail 62 or intermediate rail 72. When the inner rail 61 or 71 is extended out, the retaining end 641 or 741 of the release member 64 or 74 will be stopped against the stop member 65 or 75, prohibiting falling of the inner 61 or 71 with the affixed sliding box (not shown) out of the outer rail 62 or intermediate rail 72. When going to detach the inner 61 or 71 with the affixed sliding box (not shown) from the outer rail 62 or intermediate rail 72, the user simply needs to press the release member 64 or 74, allowing the inner 61 or 71 with the affixed sliding box (not shown) to be removed from the outer rail 62 or intermediate rail 72. Further, when the inner rail 61 or 71 of the sliding rail assembly 6 or 7 is extended out, there is no means to temporarily secure the inner rail 61 or 71 in the extended position, and the inner rail 61 or 71 may be accidentally forced to move back toward the inside of the outer rail 62 or intermediate rail 72 as the user is examining the components in the drawer or operating a keyboard carried on the drawer. There are sliding rail designs providing locking devices for locking the inner rail in the extended position, avoiding accidental displacement of the inner rail. However, the locking device for this purpose has a complicated structure and is expensive to manufacture and requires much installation time and labor. Further, when going to push the drawer from the extended position back to the received position, the user must unlock the two locking devices at the two opposite lateral sides of the drawer with both hands so that the inner rails of the two sliding rail assemblies at the two opposite lateral sides of the drawer can be moved relative to the associating outer rails or intermediate rails. Further, the arrangement of the locking device relatively increases the vertical height of the respective sliding rail assembly, causing the sliding rail assembly to be not applicable to a server or low profile keyboard drawer.

Further, when operating the sliding rail assembly 6, as shown in FIG. 2, to push the inner rail 61 back to the inside of the outer rail 62, as shown in FIGS. 3 and 4, the extension arm 640 of the release member 64 that protrudes over the edges of the sidewalls 610 of the inner rail 61 a certain distance 60 (see FIG. 3) tends to be jammed in the cabinet or server housing in which the outer rail 62 is installed. Further, the release member 64 causes a great deal of friction resistance during sliding movement of the inner rail 61 relative to the outer rail 62, resulting in vibration of the sliding movement of the inner rail 61. Further, when going to detach the inner rail 61, the user needs to press the front end 6401 of the back part 640 of the release member 64 for causing disengagement of the retaining portion 641 of the release member 64 from the stop member 65 at the outer rail 62, however, the release member 64 may be not sufficiently elastically deformed to disengage the retaining portion 641 from the stop member 6, complicating the dismounting operation.

### SUMMARY OF THE INVENTION

The present invention has been accomplished under the circumstances in view. It is the main object of the present invention to provide an inner rail release and positioning structure, which enables the inner rail to be directly pushed back to the inside of the outer rail (or intermediate rail) without operating any locking device, and the damping spring plate that is adapted for holding the inner rail positively in the extended position will be elastically deformed and moved over the stop member at the outer rail for allowing the inner rail to be received in the outer rail (or intermediate rail).

It is another object of the present invention to provide an inner rail release and positioning structure, which enables a damping spring plate to be elastically deformed to pass over a stop member at an outer rail (or intermediate rail) when the user is pulling an inner rail out of the outer rail (or intermediate rail), and the damping spring plate will immediately return to its former shape and be stopped at the stop member to prohibit the extended inner rail from backward displacement.

It is still another object of the present invention to provide an inner rail release and positioning structure, which allows the user to detach the inner rail from the outer rail (or intermediate rail) easily by means of pressing a second inclined portion of the extension arm of the release spring plate to disengage the extension arm of the release spring plate from the stop member.

It is still another object of the present invention to provide an inner rail release and positioning structure, which uses low profile release spring plate and damping spring plate, enabling the sliding rail assembly to have a low profile characteristic practical for use in a server or low profile drawer, and therefore, the invention has significant industrial value.

It is still another object of the present invention to provide an inner rail release and positioning structure, wherein the release spring plate and the damping spring plate are simple components that are easy and inexpensive to manufacture, enhancing product competitiveness.

To achieve these and other objects of the present invention, an inner rail release and positioning structure comprises a release spring plate affixed to an inner rail of a sliding rail assembly and having an extension arm defining a first inclined portion, a relatively shorter second inclined portion obliquely extended from the first inclined portion and a relatively longer third inclined portion obliquely extended from the second inclined portion remote from the first inclined portion at a relatively smaller inclined angle than the inclined angle of the second inclined portion, a stop member affixed to the front end of the outer rail of the sliding rail assembly and engageable with the release spring plate, a damping spring plate mounted at the inner rail for stopping against the stop member to prohibited the extended inner rail from backward displacement and defining a front damping portion obliquely outwardly extended from the mounting base thereof, a connection portion backwardly extended from an opposite end of the front damping portion, a rear damping portion obliquely inwardly extended from the opposite end of the connection portion and a rear support portion backwardly extended from the opposite end of the rear damping portion for allowing quick dismounting of the inner rail.

Thus, when pulling the inner rail out of the outer rail to the extended position, the front damping portion of the damping spring plate will be forced against the retaining lug of the stop member, causing deformation of the damping spring plate and allowing the damping spring plate to pass forwardly over the retaining lug of the stop member, and the rear damping portion will be stopped at the front side of the retaining lug of the stop member to prohibit the inner rail from backward displacement relative to the outer rail.

When going to push the inner rail from the extended position back to the inside of the outer rail, the user needs not to operate any locking mechanism but simply needs to push the inner rail directly toward the inside of the outer rail to force the rear damping portion of the damping strip against the retaining lug of the stop member, causing deformation of the damping spring plate and allowing the damping spring plate to pass backwardly over the retaining lug of the stop member, and therefore the inner rail can be positively received in the outer rail.

Further, when moving the inner rail relative to the outer rail (or intermediate rail), the damping spring plate does not cause much friction resistance.

Further, when going to detach the inner rail, press the second inclined portion of the extension arm of the release spring plate to disengage the extension arm of the release spring plate from the retaining lug of the stop member, and the inner rail is unlocked and can be detached from the outer rail (or intermediate rail) directly.

### BRIEF DESCRIPTION OF THE DRAWING

FIG. 1 is an exploded of a three-step sliding rail assembly according to the prior art.

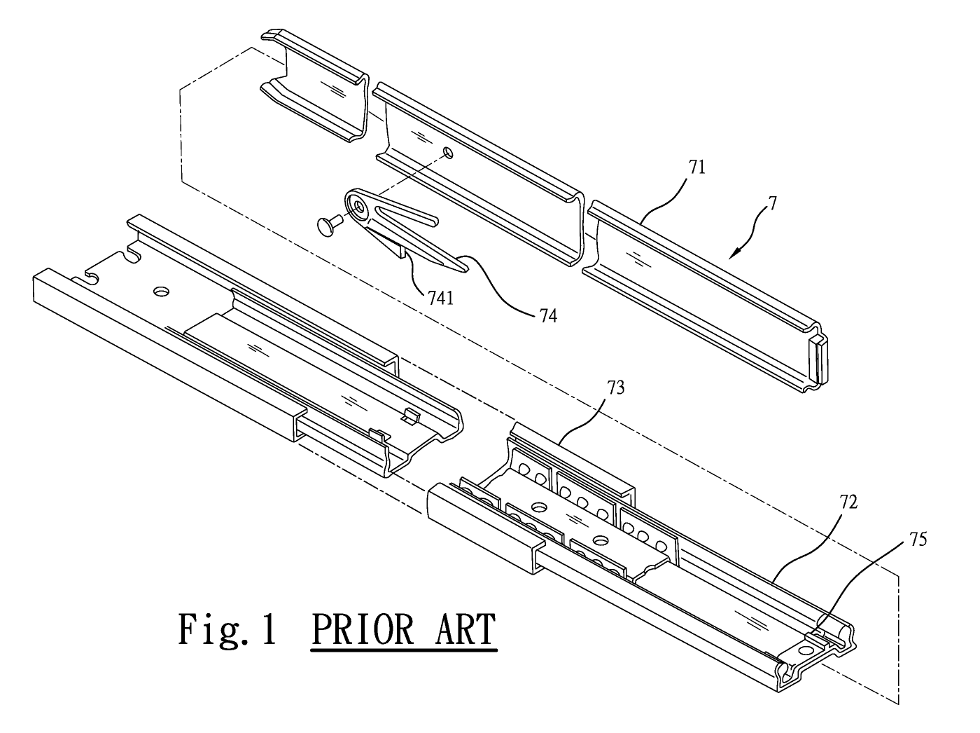

FIG. 2 is an exploded view of a two-step sliding rail assembly according to the prior art.

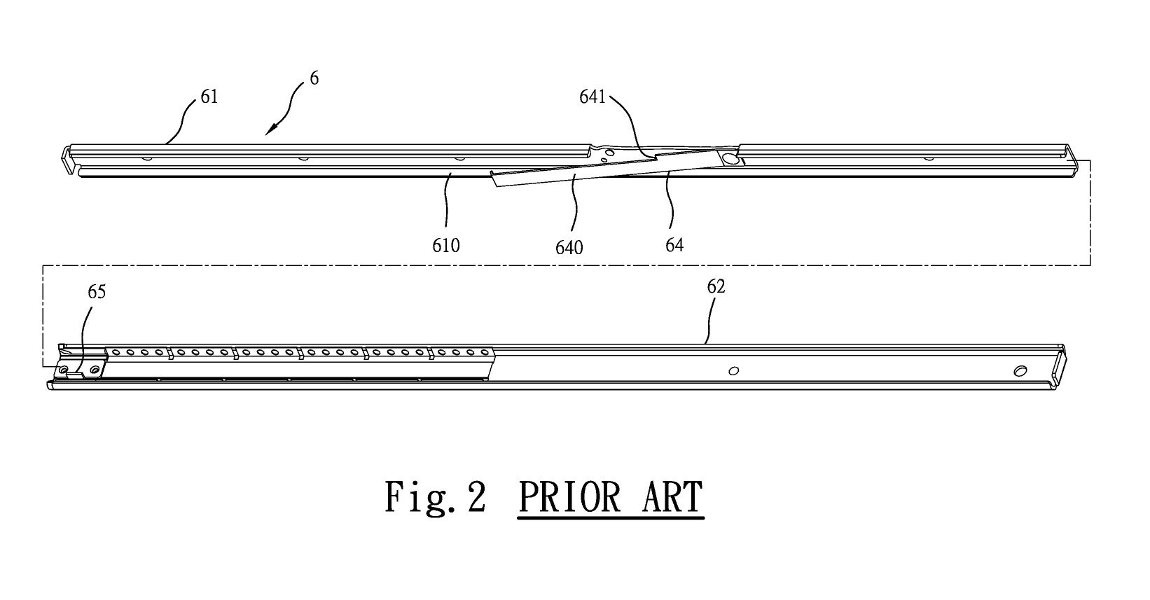

FIG. 3 is a schematic sectional plain view of the prior art two-step sliding rail assembly, illustrating the release member of the inner rail partially entered the outer rail and partially out disposed outside the outer rail.

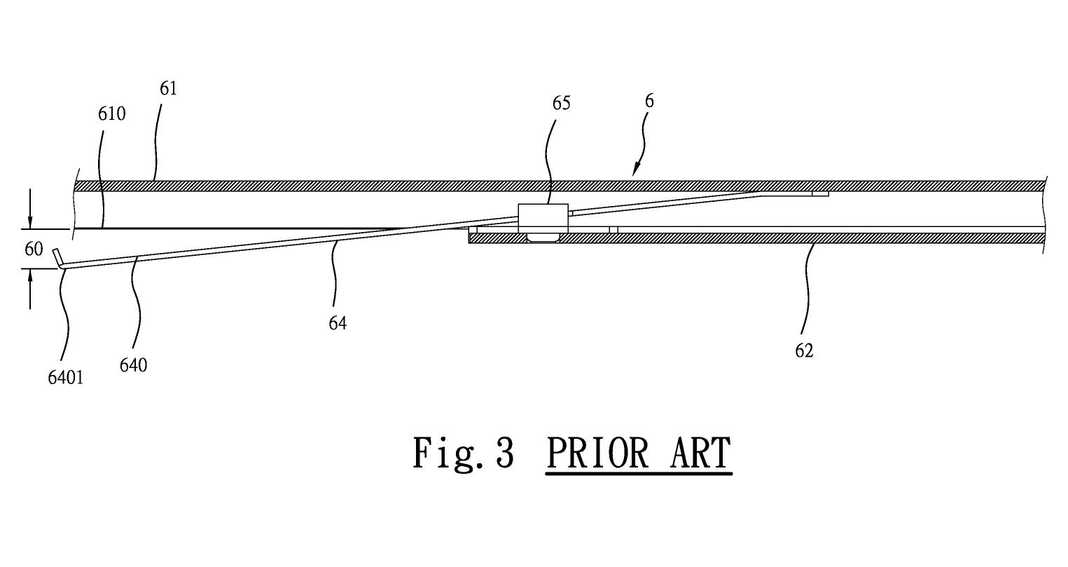

FIG. 4 corresponds to FIG. 3, illustrating the release member completely entered the outer rail.

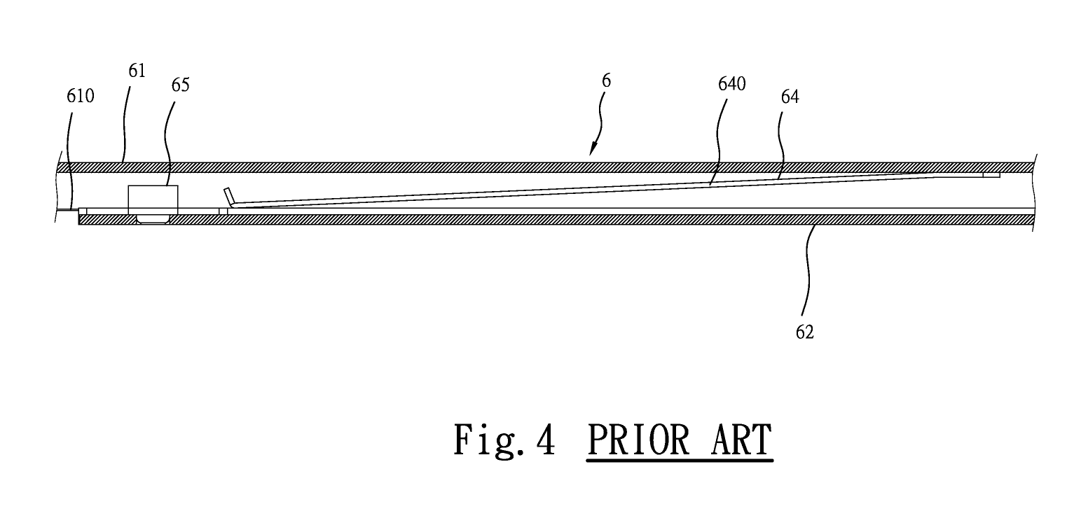

FIG. 5 is an exploded view of an inner rail release and positioning structure in accordance with the present invention.

FIG. 6 is an elevational view of the an inner rail release and positioning structure in accordance with the present invention, illustrating the inner rail extended out of the outer rail.

FIG. 7 is another elevational view of the inner rail release and positioning structure in accordance with the present invention, illustrating the inner rail received in the outer rail.

FIG. 8 is an exploded view of the inner rail and the related components of the inner rail release and positioning structure in accordance with the present invention when viewed from another angle.

FIG. 9 is a sectional elevation of the inner rail and the related components of the inner rail release and positioning structure in accordance with the present invention.

FIG. 10 is a schematic elevational view, in an enlarged scale, of a part of the present invention, illustrating the damping spring plate at the intermediate rail stopped by the stop plate at the outer rail.

FIG. 11 is a schematic sectional view, in an enlarged scale, of a part of the present invention, illustrating the damping spring plate at the intermediate rail stopped by the stop member at the outer rail.

FIG. 12 is a schematic sectional view, in an enlarged scale, of a part of the present invention, illustrating the damping spring plate forced against the stop member at the outer rail and elastically deformed.

FIG. 13 corresponds to FIG. 12, illustrating the damping spring plate moved over the stop member at the outer rail during backward sliding movement of the inner rail.

FIG. 14 is a schematic sectional view, in an enlarged scale, of a part of the present invention, illustrating the release spring plate of the inner rail partially entered the outer rail.

FIG. 15 corresponds to FIG. 14, illustrating the release spring plate of the inner rail completely entered the outer rail.

### DETAILED DESCRIPTION OF THE INVENTION

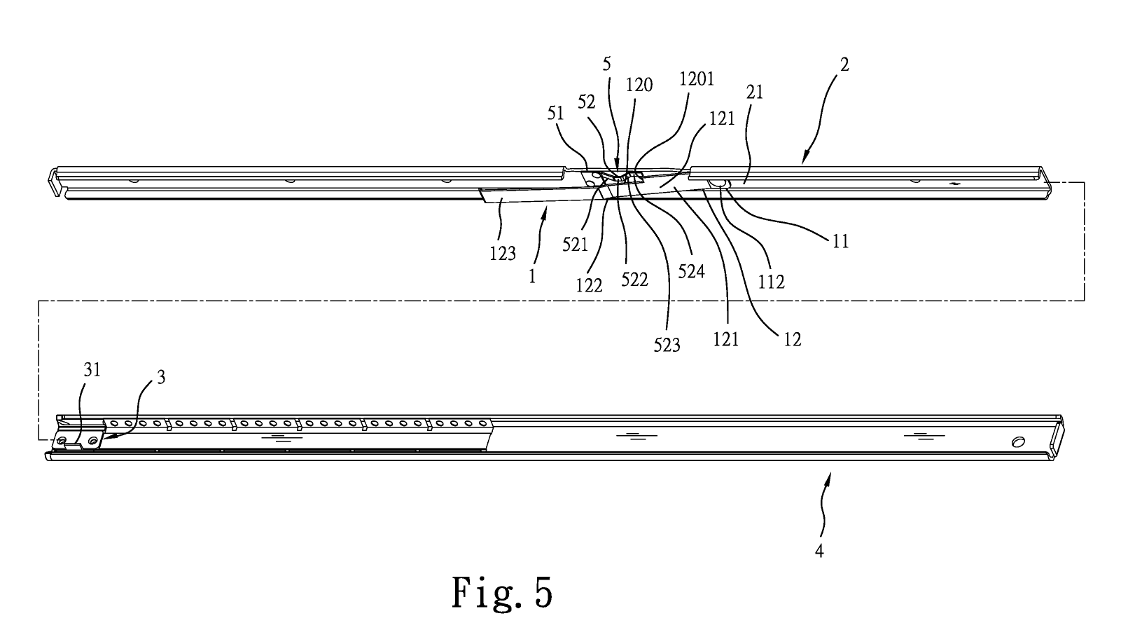

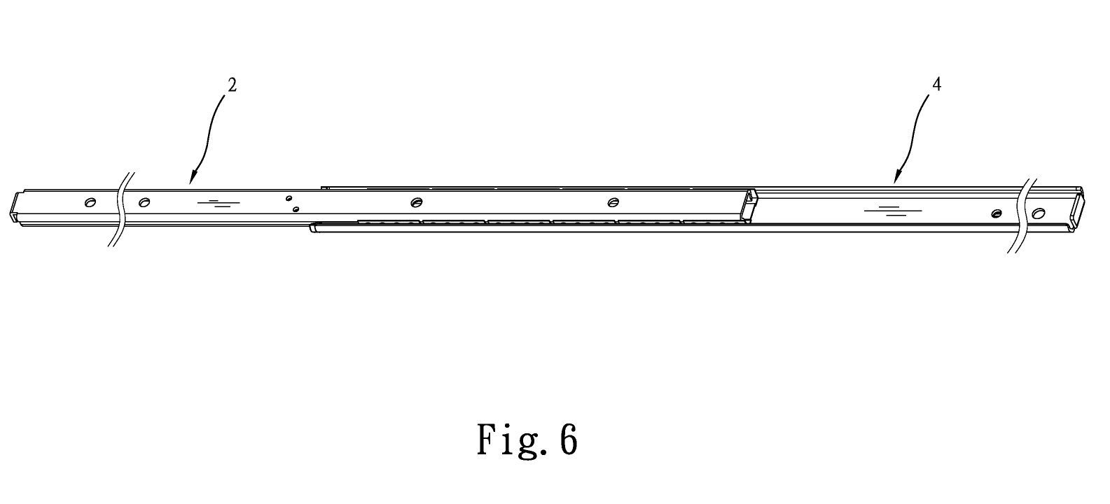

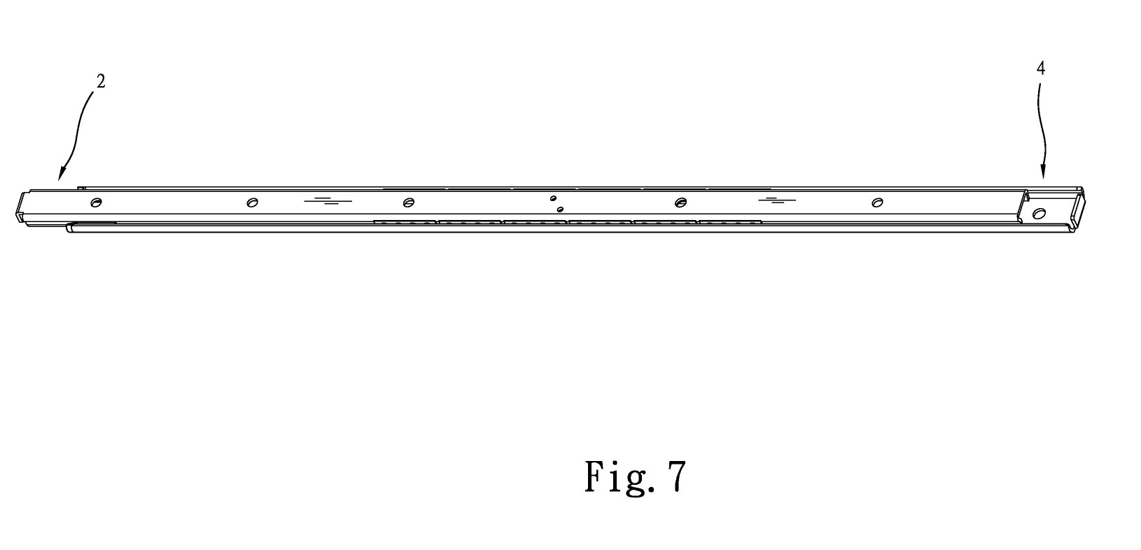

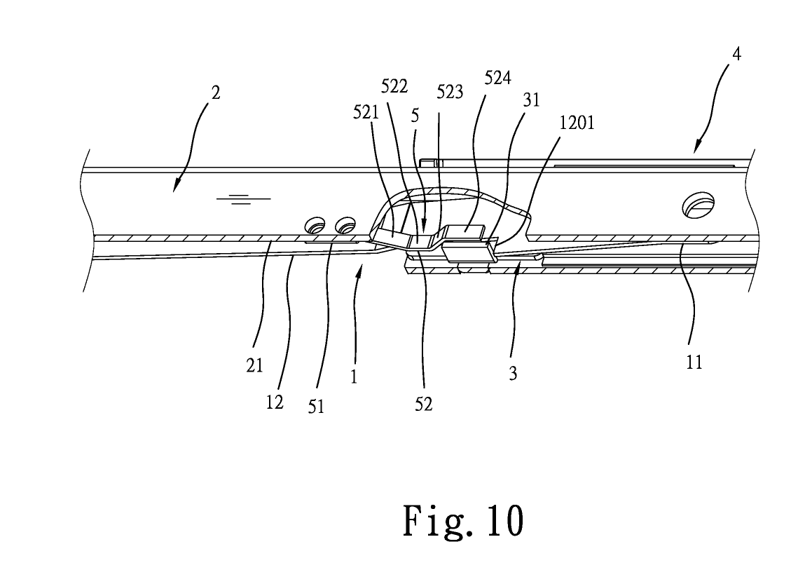

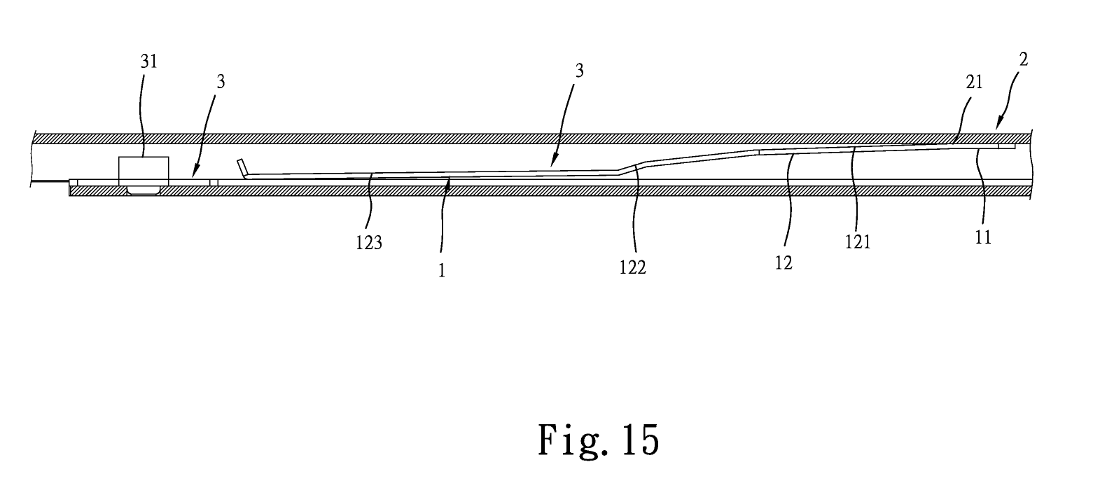

Referring to FIGS. 5-15, an inner rail release and positioning structure in accordance with the present invention is shown comprising:

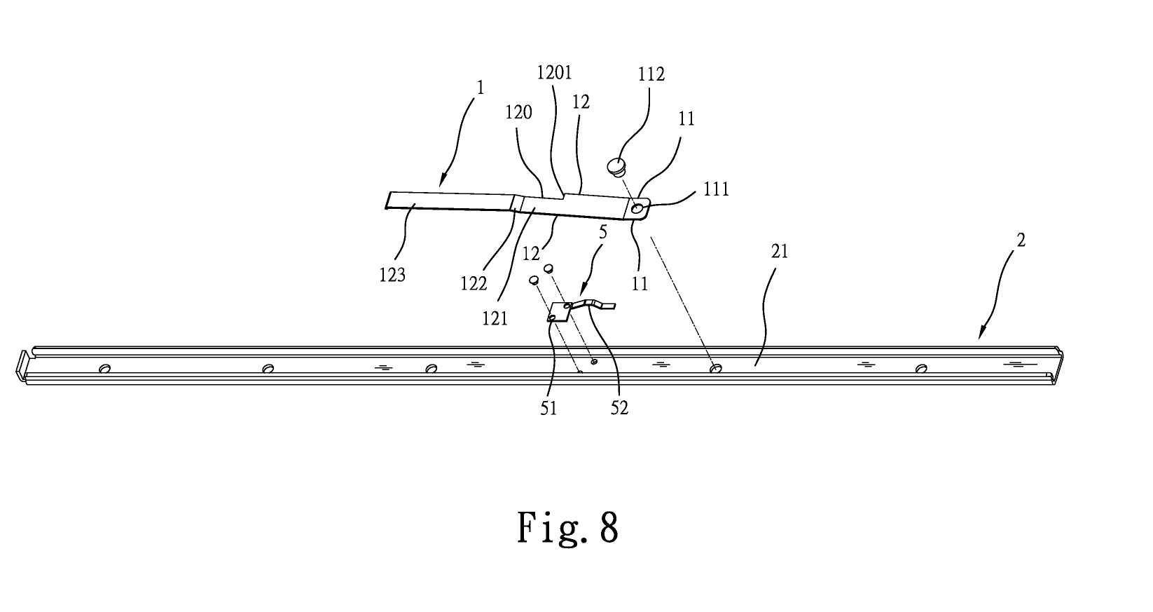

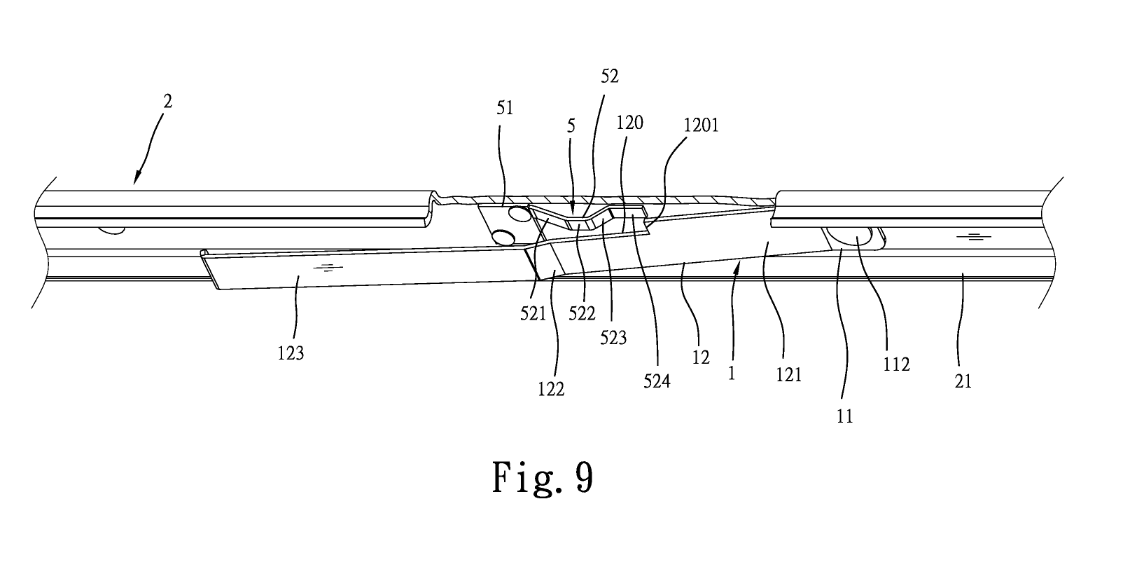

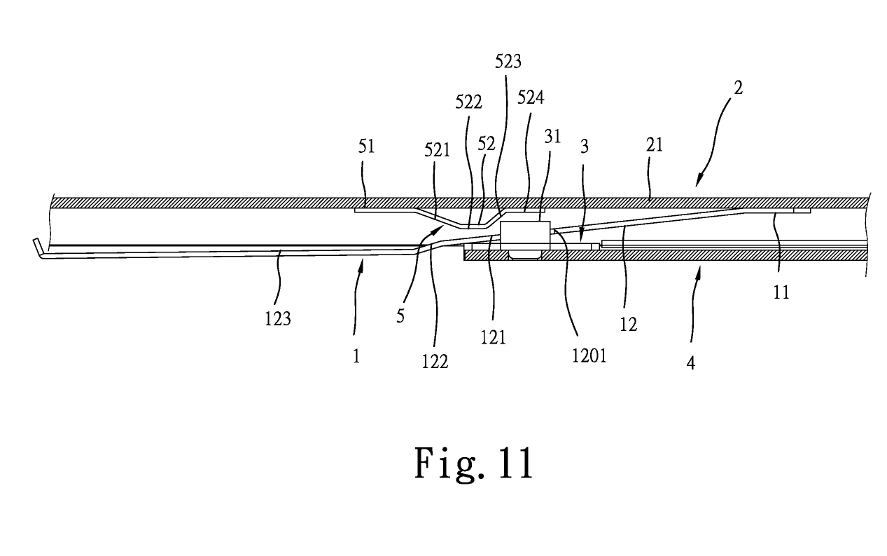

a release spring plate 1, which comprises a mounting portion 11, an extension arm 12, which defines a first inclined portion 121 obliquely extended from one end of the mounting portion 11 (see FIG. 9 and FIG. 11), a mounting through hole 111 located on the mounting portion 11 (see FIG. 8) and affixed to a base wall 21 of an inner rail 2 with a fastening member, for example, rivet 112, and a notch 120 located on one lateral side of the extension arm 12 (see FIG. 9) and defining a retaining edge 1201; and

a stop member 3 affixed to a front end of an outer rail 4 (in this embodiment, the sliding rail assembly consists of an inner rail 2 and an outer rail 4; for use in a sliding rail assembly consisting of an inner rail, an intermediate rail and an outer rail, the stop member is to be affixed to the front end of the intermediately rail) and defining a retaining lug 31 detachably engageable with the retaining edge 1201 of the extension arm 12 of the release spring plate 1.

The main feature of the present invention is outlined hereinafter.

A damping spring plate 5 is mounted at the base wall 21 of the inner rail 2, comprising a mounting base 51 and a damping strip 52 extended from one end of the mounting base 51 and facing toward the notch 120 of the extension arm 12 of the release spring plate 1. The damping strip 52 comprises a front damping portion 521 obliquely outwardly extended from the mounting base 51, a connection portion 522 backwardly extended from the other end of the front damping portion 521, a rear damping portion 523 obliquely inwardly extended from the other end of the connection portion 522, and a rear support portion 524 backwardly extended from the other end of the rear damping portion 523. Further, the extension arm 12 of the release spring plate 1 at the inner rail 2 further comprises a relatively shorter second inclined portion 122 obliquely extended from one end of the first inclined portion 121 remote from the mounting portion 11 at a relatively smaller inclined angle than the inclined angle of the first inclined portion 121, and a relatively longer third inclined portion 123 obliquely extended from one end of the second inclined portion 122 remote from the first inclined portion 121 at a relatively smaller inclined angle than the inclined angle of the second inclined portion 122.

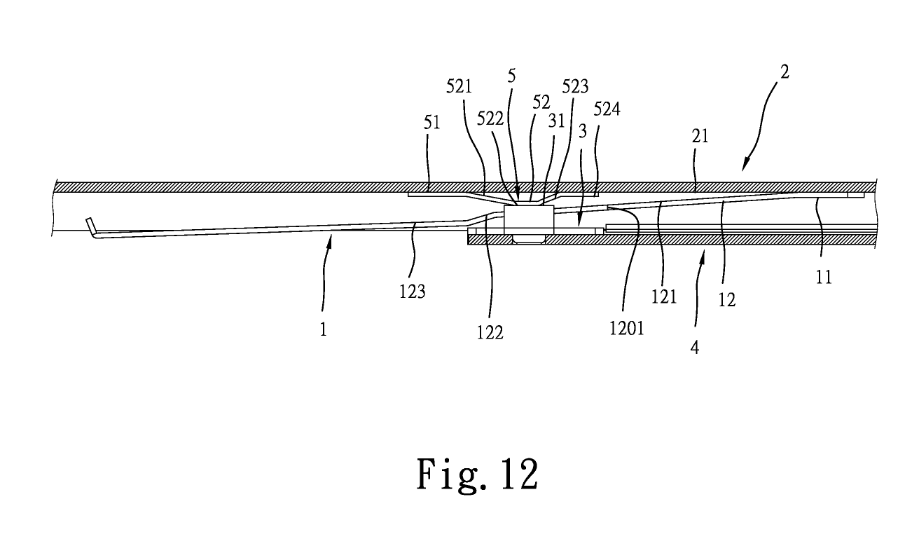

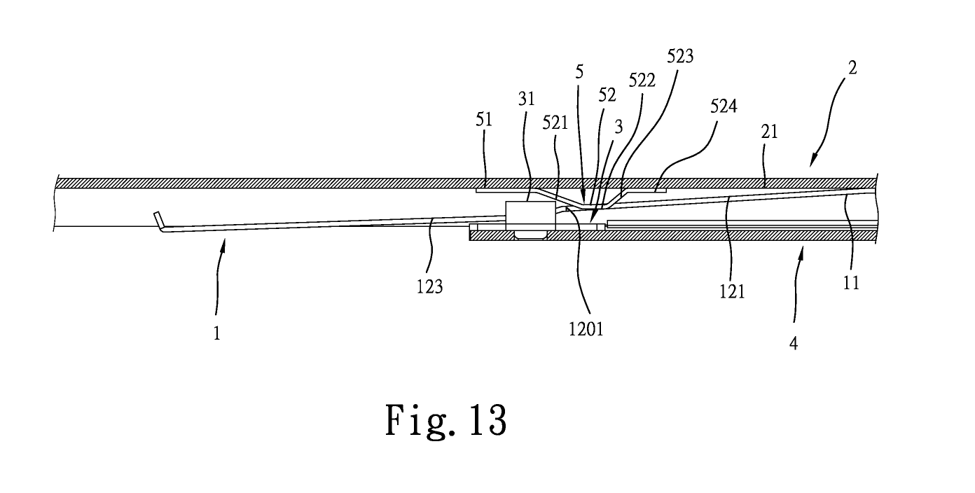

Based on the aforesaid composition, when the inner rail 2 is extended out of the outer rail 4, the retaining edge 1201 of the extension arm 12 of the release spring plate 1 will be stopped by the retaining lug 31 of the stop member 3, avoiding falling of the inner rail 2 out of the outer rail 4 (see FIG. 11), Further, when the inner rail 2 is been pulled out of the outer rail 4, the front damping portion 521 of the damping strip 52 will be forced against the retaining lug 31 of the stop member 3, causing deformation of the damping strip 52 and allowing the damping spring plate 5 to pass forwardly over the retaining lug 31 of the stop member 3. After the damping spring plate 5 passed over the retaining lug 31 of the stop member 3, the rear damping portion 523 is stopped at the front side of the retaining lug 31 of the stop member 3 (see FIG. 11), prohibiting the inner rail 2 from backward displacement relative to the outer rail 4, and therefore the inner rail 2 is kept in the extended position. Further, when going to push the inner rail 2 back to the inside of the outer rail 4, it needs not to operate any locking mechanism but simply needs to push the inner rail 2 directly toward the inside of the outer rail 4 to force the rear damping portion 523 of the damping strip 52 against the retaining lug 31 of the stop member 3 (see FIG. 12), causing deformation of the damping strip 52 and allowing the damping spring plate 5 to pass backwardly over the retaining lug 31 of the stop member 3 (see FIG. 13), and therefore the inner rail 2 can be positively received in the outer rail 4.

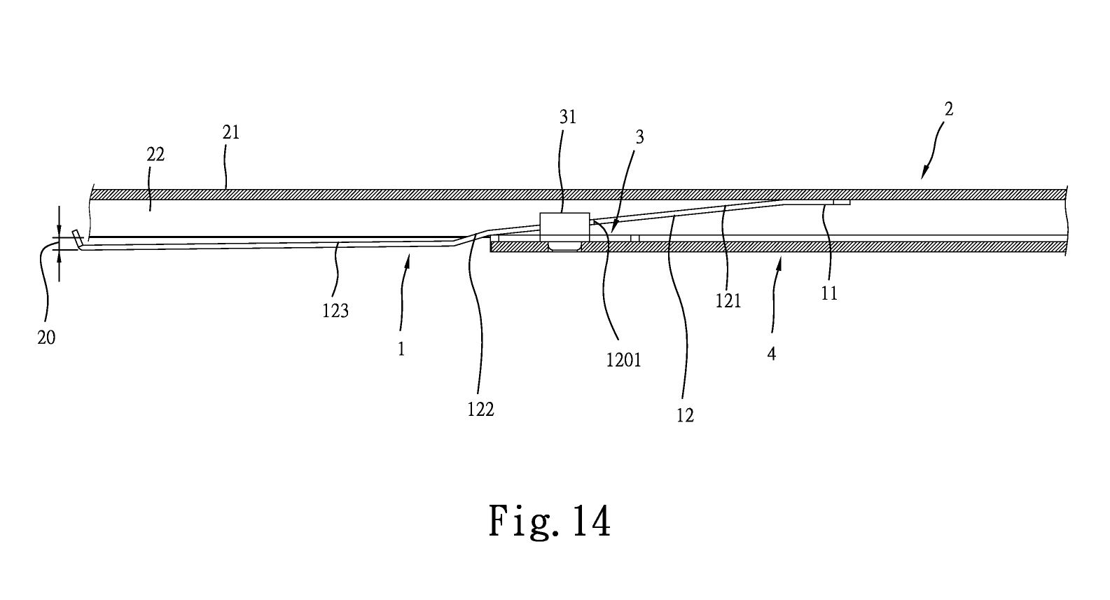

In conclusion, the invention provides an inner rail release and positioning structure, which has the advantages and features as follows:
1. When going to push the inner rail 2 from the extended position back to the inside of the outer rail 4 to close the drawer (not shown), the user needs not to operate any locking mechanism but simply needs to push the inner rail 2 directly toward the inside of the outer rail 4 to force the rear damping portion 523 of the damping strip 52 against the retaining lug 31 of the stop member 3 (see FIG. 12), causing deformation of the damping strip 52 and allowing the damping spring plate 5 to pass backwardly over the retaining lug 31 of the stop member 3 (see FIG. 13), and therefore the inner rail 2 can be positively received in the outer rail 4.
2. When pulling the inner rail 2 out of the outer rail 4 from the received position to the extended position to open the drawer, the front damping portion 521 of the damping strip 52 will be forced against the retaining lug 31 of the stop member 3, causing deformation of the damping strip 52 and allowing the damping spring plate 5 to pass forwardly over the retaining lug 31 of the stop member 3, and the rear damping portion 523 will be stopped at the front side of the retaining lug 31 of the stop member 3 (see FIG. 11) to prohibit the inner rail 2 from backward displacement relative to the outer rail 4 after the drawer having been opened, i.e., after pulling out the inner rail 2 to open the drawer for examining the components carried in the drawer or operating the keyboard of the keyboard dock carried on the drawer, the drawer and the inner rail 2 will not be forced accidentally to move back to the inside of the outer rail 4.
3. The extension arm 12 of the release spring plate 1 comprises a first inclined portion 121 obliquely extended from one end of the mounting portion 11 of the release spring plate 1, a relatively shorter second inclined portion 122 obliquely extended from one end of the first inclined portion 121 remote from the mounting portion 11 at a relatively smaller inclined angle than the inclined angle of the first inclined portion 121, and a relatively longer third inclined portion 123 obliquely extended from one end of the second inclined portion 122 remote from the first inclined portion 121 at a relatively smaller inclined angle than the inclined angle of the second inclined portion 122. Thus, the distance 20 in which the third inclined portion 123 protrudes over the side edge of the sidewall 22 of the inner rail 2 is short (see FIG. 14), giving less friction resistance to the outer rail 4 and facilitating sliding movement of the inner rail 2 relative to the outer rail 4. Further, when going to detach the inner rail 2, press the second inclined portion 122 of the extension arm 12 of the release spring plate 1 to disengage the retaining edge 1201 of the extension arm 12 of the release spring plate 1 from the retaining lug 31 of the stop member 3, and the inner rail 2 is unlocked and can be detached from the outer rail 4.
4. The release spring plate 1 and the damping spring plate 5 do not require much vertical space for installation, and therefore the sliding rail assembly has a low profile characteristic practical for use in a server or low profile drawer, i.e., the invention has significant industrial value.
5. The release spring plate 1 and the damping spring plate 5 are simple components that are easy and inexpensive to manufacture, enhancing product competitiveness.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An inner rail release and positioning structure, comprising:
a release spring plate comprising a mounting portion, an extension arm obliquely extended from one end of said mounting portion and defining a first inclined portion, a mounting through hole located on said mounting portion and affixed to a base wall of an inner rail of a sliding rail assembly with a fastening member, and a notch located on one lateral side of said extension arm and defining a retaining edge; and
a stop member affixed to a front end of an outer rail of said sliding rail assembly and defining a retaining lug detachably engageable with said retaining edge of said extension arm of said release spring plate;
wherein the inner rail release and positioning structure further comprises a damping spring plate mounted at the base wall of said inner rail, said damping spring plate comprising a mounting base and a damping strip extended from one end of said mounting base and facing toward said notch of said extension arm of said release spring plate, said damping strip comprising a front damping portion obliquely outwardly extended from said mounting base, a connection portion backwardly extended from an opposite end of said front damping portion, a rear damping portion obliquely inwardly extended from an opposite end of said connection portion, and a rear support portion backwardly extended from an opposite end of said rear damping portion; said extension arm of said release spring plate further comprises a relatively shorter second inclined portion obliquely extended from one end of said first inclined portion remote from said mounting portion at a relatively smaller inclined angle than the inclined angle of said first inclined portion.

2. The inner rail release and positioning structure as claimed in claim 1, wherein said extension arm of said release spring plate further comprises a relatively longer third inclined portion obliquely extended from one end of said second inclined portion remote from said first inclined portion at a relatively smaller inclined angle than the inclined angle of said second inclined portion.
